(19) United States
(12) Patent Application Publication
(10) Pub. No.: US 2023/0105039 A1
(43) Pub. Date: Apr. 6, 2023

(54) NETWORK BENCHMARKING ARCHITECTURE

(71) Applicant: SAP SE, Walldorf (DE)

(72) Inventors: Christopher Chase, Palo Alto, CA (US); Pierre Alexis Oger, Meyreuil (FR); Michal Cieslak, Pittsburgh, PA (US)

(21) Appl. No.: 17/495,415

(22) Filed: Oct. 6, 2021

(51) Int. Cl. G06Q 10/06; G06F 3/0481; G06K 9/62; G06N 20/00

(52) U.S. Cl. CPC G06Q 10/06393; G06F 3/04817; G06K 9/6256; G06N 20/00

(57) ABSTRACT

In an example embodiment, a machine-learned model is trained to predict a region and industry for an organization. This region and industry information can then be used as part of a data enrichment process where data regarding the organization is “tagged” with the predicted industry and region information, allowing for a benchmarking tool to readily group organizational data by region and/or industry for meaningful comparison. This allows or the benchmarking tool to scale, as without the machine-learned model it would be necessary for a human to assign a region and industry to each organization missing that information, which may work for small numbers of organizations but would be impractical for large numbers of organizations.

### BACKGROUND

Many business-to-business (B-to-B) transactions, such as a company purchasing goods from a supplier, are handled via interactions between computer programs. Sometimes there may be a variety of different computer systems involved in a single transaction. One piece of software running on a supplier system may handle requests for proposals from companies and send terms for a transaction. Another piece of software running on a company system may receive the proposal and send a purchase order. Other pieces of software running on the supplier system and company system may handle invoicing and remittance of payments, respectively, and so on. Of course, the purchaser may have their own purchaser system that generates requests for proposals, terms, purchase orders, and the like.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for benchmarking organizational data, in accordance with an example embodiment.

FIG. 2 is a screen capture illustrating a graphical user interface rendered by an insights application, in accordance with an example embodiment.

FIG. 3 is a screen capture of other widgets in accordance with an example embodiment.

FIG. 4 is a flow diagram illustrating a method for training and using a machine learned model in accordance with an example embodiment.

FIG. 5 is a block diagram illustrating an example architecture of software, which can be installed on any one or more of the devices described above.

FIG. 6 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Middleware management software may lie in the middle of the various purchaser and supplier systems and aid in management of the documents and their related workflows.

Middleware management software may offer various benchmarking options to suppliers and purchasers. For example, for suppliers, the middleware management software may break down performance by customer, competitor, or industry. This information can then be used to identify gaps in an organization’s processes in order to achieve a competitive advantage. Benchmarking is a powerful tool to understand performance, but if can be difficult, time, consuming, and costly. Small and mid-size companies do not have the time or resources to benchmark their performance or that of their customers.

There are numerous technical issues with scaling supplier benchmarking software tools to large numbers of suppliers. One technical issue is that benchmarking typically involves comparing organizations within a single region and/or industry, but the region and industry of an organization are not always readily available. As such, in an example embodiment, a machine-learned model is trained to predict a region and industry for an organization. This region and industry information can then be used as part of a data enrichment process where data regarding the organization is “tagged” with the predicted industry and region information, allowing for a benchmarking tool to readily group organizational data by region and/or industry for meaningful comparison. This allows the benchmarking tool to scale, as without the machine-learned model it would be necessary for a human to assign a region and industry to each organization missing that information, which may work for small numbers of organizations but would be impractical for large numbers of organizations.

Another technical issue is that the data about the organization may be obtained from multiple sources, and each source may not organize and scale its data in the same way. For example, one organization may track sales using fiscal year targets, while another organization may track sales using calendar year targets. Another example would be that one organization may track customer satisfaction ratings with a scale of 0-100 while another may track customer satisfaction ratings with a scale of 1-5. In an example embodiment, organization data is collected and normalized, so that similar data is organized and scaled in an identical manner, no matter which organization’s data is being analyzed.

Another technical issue is that the data about the organizations may not always be correct and/or meaningful. Errors may be introduced into the data through data entry error or software bugs. Additionally, sometimes even correct data may not be meaningful for analysis purposes. For example, an outlier may exist due to a one-off event that may make particular data skew results in a way that is not representational of organizational performance. For example, if the organization is an oil refinery and hurricane caused the oil refinery to be unusable for a week during a particular month, while other oil refineries in the region were able to maintain service, the sales data for that month may not be all that meaningful for benchmarking purposes, even if it is accurate. In an example embodiment, a service is provided that identifies and eliminates bad data and anomalies that either disrupt the benchmark calculations or interfere with the presentation of the corresponding KPI or benchmark.

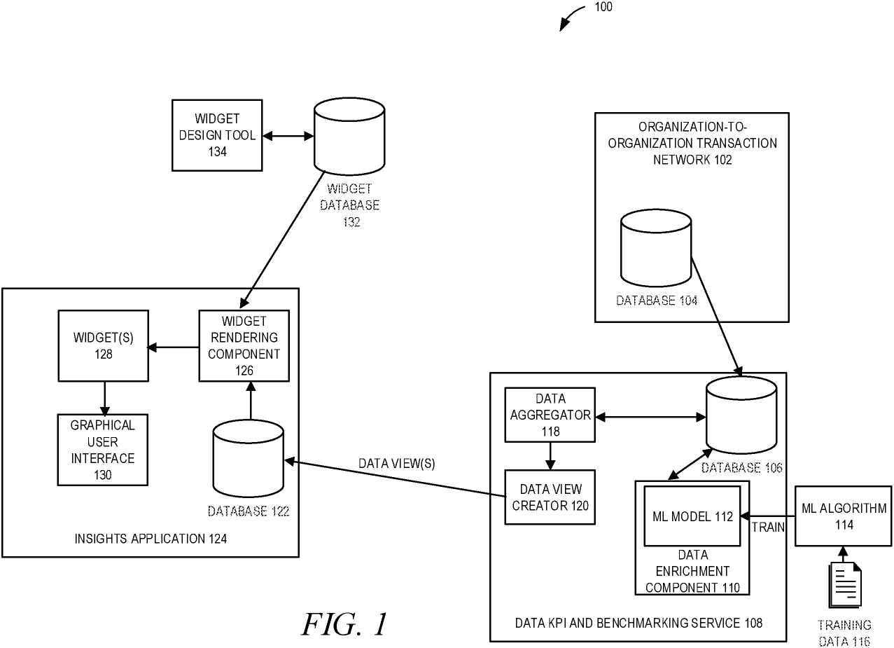

FIG. 1 is a block diagram illustrating a system 100 for benchmarking organizational data, in accordance with an example embodiment. An organization-to-organization transaction network 102 allows for organizations to discover other organizations, transaction with other organizations, and track such transactions.

Transactional and other organizational data may be stored in database 104. In an example embodiment, database 104 is an in-memory database. An in-memory database system is a database management system that uses main memory for data storage. In some examples, main memory comprises random access memory (RAM) that communicates with one or more processors, e.g., central7 processing units (CPU 402s), over a memory bus. An in-memory database system can be contrasted with database management systems that employ a disk storage mechanism. In some examples, in-memory database systems are faster than disk storage databases, because internal optimization algorithms can be simpler and execute fewer CPU instructions. In some examples, accessing data in an in-memory database system eliminates seek time when querying the data, which provides faster and more predictable performance than disk-storage databases. In some examples, an in-memory database can be provided as a column-oriented in-memory database, in which data tables are stored as sections of columns of data (rather than as rows of data). An example in-memory database system comprises HANA, provided by SAP SE of Walldorf, Germany.

This data may comprise not just transactional information (e.g, sales, collections, etc.) but also information about the organizations involved in the transactions, including region and industry information. Region information indicates a geographical region (e.g., Northwest) for an organization. Industry indicates an industry type (e.g., Oil & Gas, Software, Healthcare) for the organization. In some instances, however, region and/or industry information may be missing from the information stored in the database 104.

In an example embodiment, the organization-to-organization transaction network 102 is redesigned to encourage normalization and address discrepancies in the context of regular transactional activities. For example, organizations may be asked to collect and report customer satisfaction ratings in a particular scale.

Data from database 104 may then be sent to database 106 located in a data KPI and benchmarking service 108. The data KPI and benchmarking service 108 aggregates and anonymizes the community data into views. View may comprise, for example, organization industry, organization region, organization performance quartile, etc. Views may be limited to specific time frames (last month, last quarter, last year).

The sending of the data from database 104 to database 106 may be performed using real-time replication. In real-time replication, data is simultaneously copied to another location as it is generated. In an example embodiment, the real-time replication is performed using smart data integration (SDI) and/or smart data access (SDA) functionality. In an example embodiment, database 106 is an in-memory database. The data KPI and benchmarking service 108 comprises a data enrichment component 110. The data enrichment component 110 enriches the data in the database 104 with additional metadata. In an example embodiment, the data enrichment component 110 comprises a machine-learned model 112. The machine-learned model 112 predicts an industry and/or region for an organization, and this prediction may be performed on a plurality of organizations whose data is in the database 106. The data enrichment component 110 may then tag corresponding data with these predictions as metadata for the corresponding data.

In an example embodiment, the machine-learned model 112 may be trained by a machine learning algorithm 114 using training data 116, to make predictions about industry and/or region for an organization. This training process will be described in more detail later in this document.

A data aggregator 118 may then aggregate the data in the database 106 based on region and/or industry of corresponding organizations. Data view creator 120 may then create a plurality of data views of the aggregated data. These data views may be specific to particular time frames, and thus may essentially involve filtering out data that does not match the appropriate time frame and other view parameters. In an example embodiment, the views created by the data view creator 120 are KPIs, each KPI corresponding to a different metric over a particular time frame for organizations of the same region and/or industry.

In an example embodiment, these data views are created using calculation views. A calculation view is a flexible information view that can be used to define advanced slices on data in an in-memory database. Calculation views allow for the functionality of attribute views and analytic views, but also provide other analytic capabilities, such as advanced data modeling logic. This comprises measures sourced from multiple source tables, or views that use advanced structured query language (SQL) logic. In an example embodiment, SQL scripts are used to create script-based calculation views.

Additionally, the data views may be created by combining data, in various different schemas, stored in database 104 using a series of database joins. Each data view may be considered to be a table dedicated to a different KPI, with some columns for the metric(s) of the KPI, some columns for versioning, and some columns for monitoring and tracking. The columns for versioning are used to roll back to a previous version if any data corruption or other technical issues are detected, and also allow for no downtime whenever adding new data, no matter the size.

Data views created by the data view creator 120 may then be sent to database 122 in insights application 124. Insights application 124 is a software program that can be run by an organization whose data is contained in databases 104 and 106. In an example embodiment, insights application 124 is a cloud-based application. In an example embodiment, database 122 is an in-memory database, such as a HANA® instance that is dedicated (i.e., unique to) the insights application 124. Notably, however, rather than real-time replication being used to send data views from database 106 to database 122, in an example embodiment a periodic data push is used to send the data views, such as performed weekly and the first of every month. In an example embodiment, the cadence (length of the periods) of these data pushes may be variable and can be adjusted by the organization running the insights application 124.

Furthermore, as each set of data views is pushed to the database 122, older versions of the data views may be deleted. It should be noted that in some example embodiments, rather than the data views being pushed to the database 122 they are sent via an Application Program Interface (API).

A widget rendering component 126 in the insights application 124 may then render one or more widgets 128, using the data views from database 122. Each widget 128 may define how a particular KPI is to be displayed in a graphical user interface presented to a user of the insights application 124. This allows for different types of presentations for different KPIs, in addition to the metric itself being different. For example, a widget for on-time payment rate may define presentation of the data view as being rendered with a radial bar chart, a widget for days to pay may define presentation of the data view as being rendered with a traditional bar chart, and a widget for value/volume of a paid invoice may defined presentation of the data view as being rendered with a line chart.

In an example embodiment, each widget may have a number of components, including a controller component, a service interface, a service implementation, and model classes. Each component may have a workflow, which comprises use of an authorization service. Each component may also implement a localization framework to be displayed in an appropriate language for each customer.

One or more of the widgets 128 may then be rendered in a graphical user interface 130 for presentation to the user of the insights application 124. In some example embodiments, the user may choose which of the widgets 128 are comprised in the graphical user interface 130, although a default selection may be made by the insights application 124 itself.

The widgets 128 to be rendered may be pushed to the insights application 124 in updates to the insights application 124, from a widget database 132. The widget database 132 may be accessible by a widget design tool 134, which allows for the creation, modification, and deletion of widgets. Notably, the widgets in widget database can be shared among many different insights applications 124 and can also be shared with other types of applications. This widgetizing of the KPI presentations allows for a modular design that streamlines KPI presentation development and allows for a uniform presentation across many different application types.

When rendered, the display of the widget (front-end) may be achieved through the use of one or more third-party API, such as Angular, chart.jos, and ng2-charts. The data is sent from the backend to the frontend in JavaScript Object Notation (JSON) format.

The columns for monitoring may contain a set of annotations to be automatically monitored. A cloud monitoring application may be used to display metrics related to monitoring and raise alerts when needed.

As described briefly earlier, in an example embodiment, the machine-learned model 112 may be trained by the machine learning algorithm 114 using training data 116, to make predictions about industry and/or region for an organization. The training data 116 may be extracted from either database 104 or database 106 and/or other sources. The training data may comprise data that comprises information about organizations, including industry and/or region for those organizations. Relevant information may be extracted from this data in the form of features. A feature is a piece of data that is relevant to the prediction of an industry and/or region for an organization. These features may be extracted from multiple different sets of reference data, such as (1) commodity assignments made upon enrollment in the organization-to-organization transaction network 102; (2) the organizations' “RFX” submissions, which comprise commodity classifications; (3) a mapping of commodities to industry; and (4) 3^{rd} party reference data with industry classifications. The 3^{rd} party reference data with industry classifications may be utilized during training as labels for the features retrieved from (1), (2), and (3).

“RFX” refers to various types of “request for” submissions, which are submissions made by an organization requesting something from another organization, such as a request for proposal, request for quotation, request for information, etc.

The machine learning algorithm 114 may be selected from among many different potential supervised or unsupervised machine learning algorithms. Examples of supervised learning algorithms comprise artificial neural networks, random forest learner trees, Bayesian networks, instance-based learning, support vector machines, linear classifiers, quadratic classifiers, k-nearest neighbor, decision trees, and hidden Markov models. Examples of unsupervised learning algorithms comprise expectation-maximization algorithms, vector quantization, and information bottleneck method. The training process comprises the machine learning algorithm 114 learning weights to assign to features of organizations that lack information about the industry and/or region. They may be learned by the machine learning algorithm trying different weights, then examining the results of a loss function applied to a score produced by applying the weights to a particular piece of training data. A similar training process may be performed for industry and region. If the loss function is not satisfied, the machine learning algorithm adjusts the weights and tries again. This is repeated in a number of iterations until the loss function is satisfied, and the weights are learned.

In an example embodiment, the machine learning algorithm 114 may be used to train two different machine-learned models 112, one to predict industry and the other to predict region. In other example embodiments, there is only one machine learned model used to predict both.

Furthermore, one or both machine-learned models 112 may be retrained at a later time, using actual feedback from users and/or additional training data. The feedback may comprise, for example, indications that the predicted industries and/or regions were not accurate, and specifying the accurate industry and/or region for each of the incorrectly-predicted ones.

Regardless, the output of the machine-learned model 112 is one or two predictions. The prediction is indicative of a particular industry and/or region that the machine-learned model 112 has predicted for the organization. Inside the machine-learned model, this may be implemented using a classifier, which takes scores calculated by the machine-learned model (which were calculated by multiplying values for input features for the organization, extracted from (1) commodity assignments made upon enrollment in the organization-to-organization transaction network 102, (2) the organization’s “RFX” submissions, which comprise commodity classifications, and (3) a mapping of commodities to industry, for each of a number of possible industries and/or regions, and classifies one industry and/or region as a likeliest candidate for the organization. The likeliest industry and/or likeliest region, as determined by the classifier, may then be output as the prediction.

It should be noted that in an example embodiment, one or more of the organization-to-organization transaction network 102, data KPI and benchmarking service 108, and insights application 124 may be implemented as a microservice or microservices. This allows each to be instantiated when needed and aids in scalability.

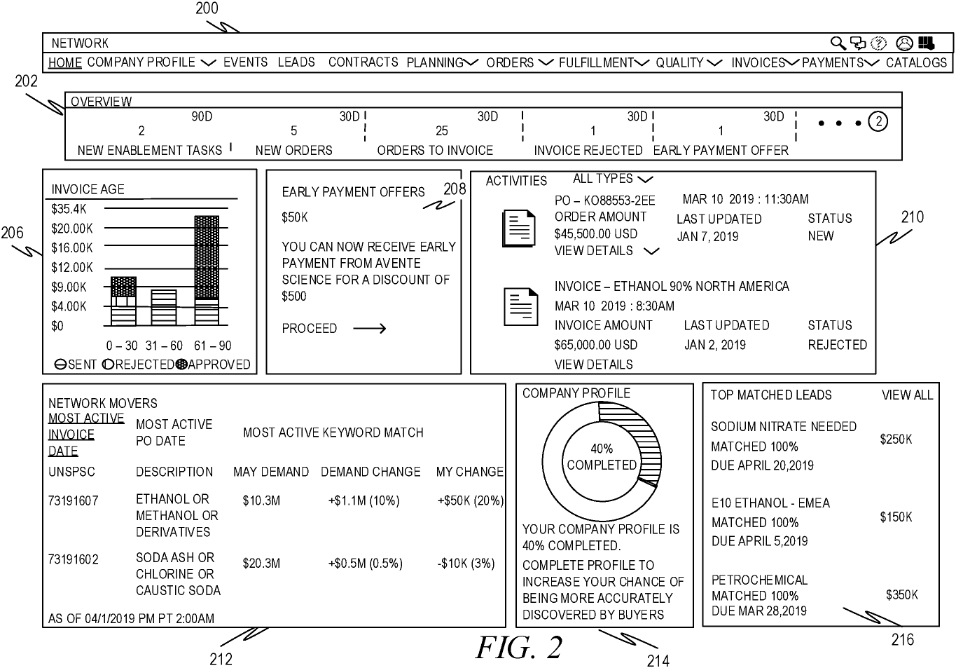

FIG. 2 is a screen capture illustrating a graphical user interface 200 rendered by an insights application 124, in accordance with an example embodiment. Here, the graphical user interface 200 comprises a dashboard 202 as well as a plurality of widgets 204, 206, 208, 210, 212, 214. The dashboard 202 may comprise various statistics about an organization, while widgets 204, 206, 208, 210, 212, 214 present other types of information. Widgets 204 and 212 are KPI widgets, which are the subject of the present document. In other words, widgets 204 and 210 may be selected from among widgets 128, and display KPIs in various different ways.

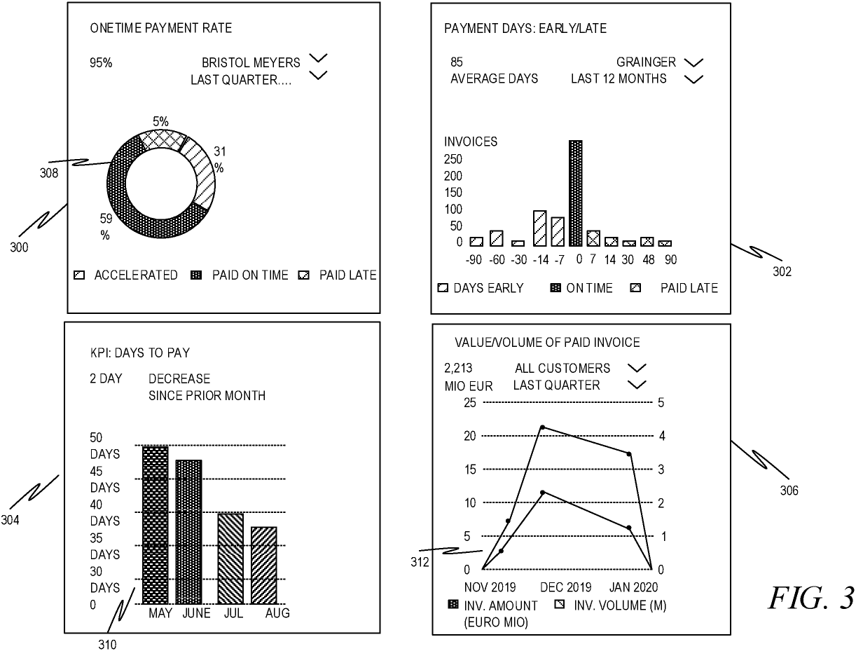

FIG. 3 is a screen capture of other widgets 300, 302, 304, 306, in accordance with an example embodiment. As can be seen, widget 300 displays the KPI “On-time payment rate” using a radial bar graph 308, widget 304 displays the KPI “Days to pay” using a traditional bar graph 310, and widget 306 displays the KPI “Value/Volume of paid invoice” using a line graph 312. There may also be selectable objects in each widget that allow for the user to select different time periods or customers/suppliers, such as selectable object 314 and selectable object 316.

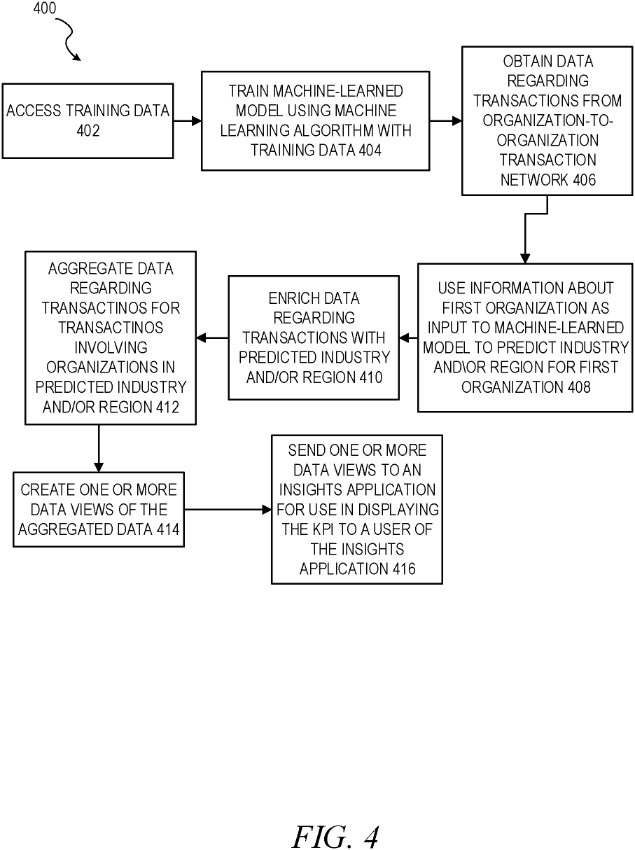

FIG. 4 is a flow diagram illustrating a method 400 for training and using a machine learned model in accordance with an example embodiment. At operation 402, training data is accessed. The training data comprises data regarding one or more organizations and, for each of the organizations, an indication of an industry corresponding to the organization. At operation 404, a machine-learned model is trained using a machine learning algorithm with the training data. The machine-learned model is trained to output, for an input organization, a predicted industry and/or region for the input organization. The training comprises extracting a set of features from the training data and using the indication of industry and/or region for each organization to learn a weight for each of one or more of the features, the predicted industry and/or region calculated by multiplying a learned weight by a value for each of the one or more features and adding their products to compute a score, the score used by a classifier within the machine-learned model to identify a likeliest industry and/or region for the input organization.

At operation 406, data regarding transactions are obtained from a first database in an organization-to-organization transaction network. At operation 408, information about a first organization is used as input to the machine-learned model to predict an industry and/or region for the first organization. This information may or may not be contained in the transactions.

At operation 410, the data regarding transactions is enriched using the predicted industry for the first organization. At operation 412, the data regarding transactions are aggregated for transactions involving organizations in the predicted industry. At operation 414, one or more data views of the aggregated data are created, each data view indicating a key performance indicator (KPI) for a particular metric over a particular time period. Then, at operation 416, the one or more data views are sent to an insights application for use in displaying the KPI to a user of the insights application.

In view of the disclosure above, various examples are set forth below. It should be noted that one or more features of an example, taken in isolation or combination, should be considered within the disclosure of this application.

Example 1. A system comprising:
at least one hardware processor; and
a non-transitory computer-readable medium storing instructions that, when executed by the at least one hardware processor, cause the at least one hardware processor to perform operations comprising:
accessing training data, the training data comprising data regarding one or more organizations and, for each of the one or more organizations, an indication of an industry corresponding to the organization;
training, using a machine learning algorithm, a machine-learned model, the machine-learned model outputting, for an input organization, a predicted industry for the input organization, the training comprising extracting a set of features from the training data and using the indication of industry for each organization to learn a weight for each of one or more of the features, the predicted industry calculated by multiplying a learned weight by a value for each of the one or more features and adding their products to compute a score, the score used by a classifier within the machine-learned model to identify a likeliest industry for the input organization;
obtaining, from a first database in an organization-to-organization transaction network, data regarding transactions;
using information about a first organization as input to the machine-learned model to predict an industry for the first organization;
enriching the data regarding transactions using the predicted industry for the first organization;
aggregate the data regarding transactions for transactions involving organizations in the predicted industry;
creating one or more data views of the aggregated data, each data view indicating a key performance indicator (KPI) for particular metric over a particular time period; and
sending the one or more data views to an insights application for use in displaying the KPI to a user of the insights application.

Example 2. The system of Example 1, wherein the training data is obtained from a plurality of different reference data sets.

Example 3. The system of Example 2, wherein the reference data sets comprise commodity assignments made upon enrollment in the organization-to-organization transaction network.

Example 4. The system of any of Examples 2-3, wherein the reference data sets comprise Request for (RFX) submissions, which comprise commodity classifications.

Example 5. The system of any of Examples 2-4, wherein the reference data sets comprise a mapping of commodities to industry.

Example 6. The system of any of Examples 2-5, wherein the training data comprises labels generated from third party reference data with industry classifications.

Example 7. The system of Example 1, wherein the insights application comprises a plurality of software widgets, each software widget corresponding to a different data view and defining a graphical presentation for the corresponding data view.

Example 8. The system of Example 7, wherein at least one software widget defines a graphical presentation of a first graph type and at least one software widget defines a graphical presentation of a second graph type.

Example 9. The system of any of Examples 7-8, wherein the plurality of software widgets is obtained from a widget database used by a plurality of different insight applications.

Example 10. The system of Example 9, wherein the widget database is additionally used by at least one software application other than an insight application.

Example 11. A method comprising:
accessing training data, the training data comprising data regarding one or more organizations and, for each of the one or more organizations, an indication of an industry corresponding to the organization;
training, using a machine learning algorithm, a machine-learned model, the machine-learned model outputting, for an input organization, a predicted industry for the input organization, the training comprising extracting a set of features from the training data and using the indication of industry for each organization to learn a weight for each of one or more of the features, the predicted industry calculated by multiplying a learned weight by a value for each of the one or more features and adding their products to compute a score, the score used by a classifier within the machine-learned model to identify a likeliest industry for the input organization;
obtaining, from a first database in an organization-to-organization transaction network, data regarding transactions;
using information about a first organization as input to the machine-learned model to predict an industry for the first organization;
enriching the data regarding transactions using the predicted industry for the first organization;
aggregate the data regarding transactions for transactions involving organizations in the predicted industry;
creating one or more data views of the aggregated data, each data view indicating a key performance indicator (KPI) for particular metric over a particular time period; and
sending the one or more data views to an insights application for use in displaying the KPI to a user of the insights application.

Example 12. The method of Example 11, wherein the training data is obtained from a plurality of different reference data sets.

Example 13. The method of Example 12, wherein the reference data sets comprise commodity assignments made upon enrollment in the organization-to-organization transaction network.

Example 14. The method of any of Examples 12-13, wherein the reference data sets comprise Request for (RFX) submissions, which comprise commodity classifications.

Example 15. The method of any of Examples 12-14, wherein the reference data sets comprise a mapping of commodities to industry.

Example 16. The method of any of Examples 12-15, wherein the training data comprises labels generated from third party reference data with industry classifications.

Example 17. A non-transitory machine-readable medium storing instructions which, when executed by one or more processors, cause the one or more processors to perform operations comprising:
accessing training data, the training data comprising data regarding one or more organizations and, for each of the one or more organizations, an indication of an industry corresponding to the organization;
training, using a machine learning algorithm, a machine-learned model, the machine-learned model outputting, for an input organization, a predicted industry for the input organization, the training comprising extracting a set of features from the training data and using the indication of industry for each organization to learn a weight for each of one or more of the features, the predicted industry calculated by multiplying a learned weight by a value for each of the one or more features and adding their products to compute a score, the score used by a classifier within the machine-learned model to identify a likeliest industry for the input organization;
obtaining, from a first database in an organization-to-organization transaction network, data regarding transactions;
using information about a first organization as input to the machine-learned model to predict an industry for the first organization;
enriching the data regarding transactions using the predicted industry for the first organization;
aggregate the data regarding transactions for transactions involving organizations in the predicted industry;
creating one or more data views of the aggregated data, each data view indicating a key performance indicator (KPI) for particular metric over a particular time period; and
sending the one or more data views to an insights application for use in displaying the KPI to a user of the insights application.

Example 18. The non-transitory machine-readable medium of Example 17, wherein the insights application comprises a plurality of software widgets, each software widget corresponding to a different data view and defining a graphical presentation for the corresponding data view.

Example 19. The non-transitory machine-readable medium of Example 18, wherein at least one software widget defines a graphical presentation of a first graph type and at least one software widget defines a graphical presentation of a second graph type.

Example 20. The non-transitory machine-readable medium of any of Examples 18-19, wherein the plurality of software widgets are obtained from a widget database used by a plurality of different insight applications.

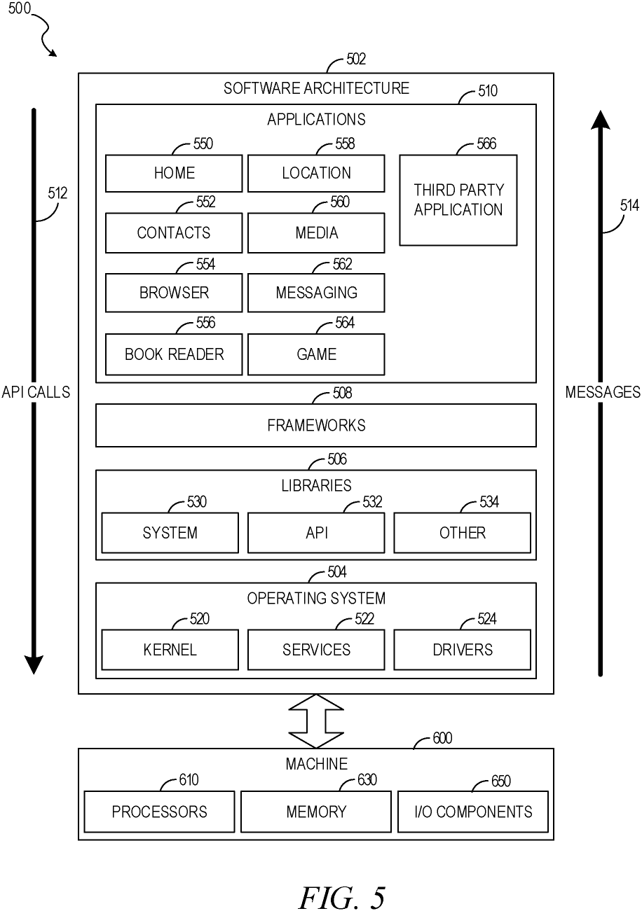

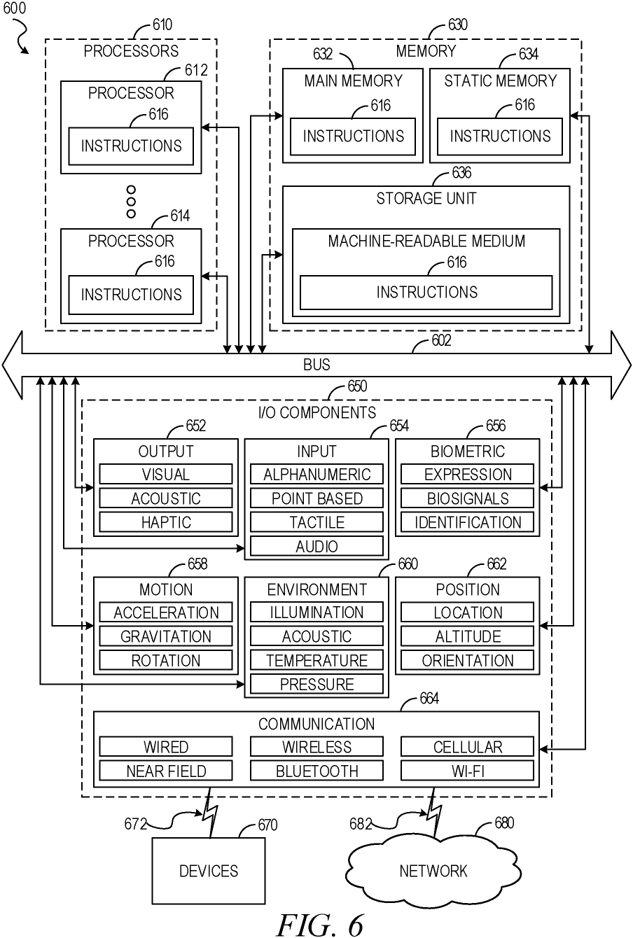

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that comprises processors 610, memory 630, and input/output (I/O) components 650. In this example architecture, the software architecture 502 can be conceptualized as a stack of layers where each layer may provide a particular functionality. For example, the software architecture 502 comprises layers such as an operating system 504, libraries 506, frameworks 508, and applications 510. Operationally, the applications 510 invoke Application Program Interface (API) calls 512 through the software stack and receive messages 514 in response to the API calls 512, consistent with some embodiments.

In various implementations, the operating system 504 manages hardware resources and provides common services. The operating system 504 comprises, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware. For instance, the drivers 524 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can comprise system libraries 530 (e.g., C standard library) that can provide functions such as memory allocation functions, string manipulation functions, mathematic functions, and the like. In addition, the libraries 506 can comprise API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 506 can also comprise a wide variety of other libraries 534 to provide many other APIs to the applications 510.

The frameworks 508 provide a high-level common infrastructure that can be utilized by the applications 510. For example, the frameworks 508 provide various graphical user interface (GUI) functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 comprise a home application 550, a contacts application 552, a browser application 554, a book reader application 556, a location application 558, a media application 560, a messaging application 562, a game application 564, and a broad assortment of other applications, such as a third-party application 566. The applications 510 can are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the methods of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to comprise a collection of machines 600 that individually or jointly execute the instructions 616 to perform any one or more of the methodologies discussed herein.

The machine 600 may comprise processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may comprise, for example, a processor 612 and a processor 614 that may execute the instructions 616. The term “processor” is intended to comprise multi-core processors that may comprise two or more independent processors (sometimes referred to as “cores”) that may execute instructions 616 contemporaneously. Although FIG. 6 shows multiple processors 610, the machine 600 may comprise a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may comprise a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor’s cache memory), or any suitable combination thereof, during execution thereof by the machine 600.

The I/O components 650 may comprise a wide variety of components to receive input, provide output, produce output, transmit information, exchange information, capture measurements, and so on. The specific I/O components 650 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 650 may comprise many other components that are not shown in FIG. 6. The I/O components 650 are grouped according to functionality merely for simplifying the following discussion, and the grouping is in no way limiting. In various example embodiments, the I/O components 650 may comprise output components 652 and input components 654. The output components 652 may comprise visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may comprise biometric components 656, motion components 658, environmental components 660, or position components 662, among a wide array of other components. For example, the biometric components 656 may comprise components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may comprise acceleration sensor components (e.g., accelerometer), gravitation sensor components, rotation sensor components (e.g., gyroscope), and so forth. The environmental components 660 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may comprise communication components 664 operable to couple the machine 600 to a network 680 or devices 670 via a coupling 682 and a coupling 672, respectively. For example, the communication components 664 may comprise a network interface component or another suitable device to interface with the network 680. In further examples, the communication components 664 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or comprise components operable to detect identifiers. For example, the communication components 664 may comprise radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (i.e., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, including memory internal or external to processors. Specific examples of machine-storage media, computer-storage media, and/or device-storage media comprise non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may comprise a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component comprised in the communication components 664) and utilizing any one of a number of well-known transfer protocols (e.g., Hypertext Transfer Protocol (HTTP)). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 616 for execution by the machine 600, and comprise digital or analog communications signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor; and
a non-transitory computer-readable medium storing instructions that, when executed by the at least one hardware processor, cause the at least one hardware processor to perform operations comprising:
accessing training data, the training data comprising data regarding one or more organizations and, for each of the one or more organizations, an indication of an industry corresponding to the organization;
training, using a machine learning algorithm, a machine-learned model, the machine-learned model outputting, for an input organization, a predicted industry for the input organization, the training comprising extracting a set of features from the training data and using the indication of industry for each organization to learn a weight for each of one or more of the features, the predicted industry calculated by multiplying a learned weight by a value for each of the one or more features and adding their products to compute a score, the score used by a classifier within the machine-learned model to identify a likeliest industry for the input organization;
obtaining, from a first database in an organization-to-organization transaction network, data regarding transactions;
using information about a first organization as input to the machine-learned model to predict an industry for the first organization;
enriching the data regarding transactions using the predicted industry for the first organization;
aggregate the data regarding transactions for transactions involving organizations in the predicted industry;
creating one or more data views of the aggregated data, each data view indicating a key performance indicator (KPI) for particular metric over a particular time period; and
sending the one or more data views to an insights application for use in displaying the KPI to a user of the insights application.

2. The system of claim 1, wherein the training data is obtained from a plurality of different reference data sets.

3. The system of claim 2, wherein the reference data sets comprise commodity assignments made upon enrollment in the organization-to-organization transaction network.

4. The system of claim 2, wherein the reference data sets comprise Request for (RFX) submissions, which comprise commodity classifications.

5. The system of claim 2, wherein the reference data sets comprise a mapping of commodities to industry.

6. The system of claim 2, wherein the training data comprises labels generated from third party reference data with industry classifications.

7. The system of claim 1, wherein the insights application comprises a plurality of software widgets, each software widget corresponding to a different data view and defining a graphical presentation for the corresponding data view.

8. The system of claim 7, wherein at least one software widget defines a graphical presentation of a first graph type and at least one software widget defines a graphical presentation of a second graph type.

9. The system of claim 7, wherein the plurality of software widgets are obtained from a widget database used by a plurality of different insight applications.

10. The system of claim 9, wherein the widget database is additionally used by at least one software application other than an insight application.

11. A method comprising:
accessing training data, the training data comprising data regarding one or more organizations and, for each of the one or more organizations, an indication of an industry corresponding to the organization;
training, using a machine learning algorithm, a machine-learned model, the machine-learned model outputting, for an input organization, a predicted industry for the input organization, the training comprising extracting a set of features from the training data and using the indication of industry for each organization to learn a weight for each of one or more of the features, the predicted industry calculated by multiplying a learned weight by a value for each of the one or more features and adding their products to compute a score, the score used by a classifier within the machine-learned model to identify a likeliest industry for the input organization;
obtaining, from a first database in an organization-to-organization transaction network, data regarding transactions;
using information about a first organization as input to the machine-learned model to predict an industry for the first organization;
enriching the data regarding transactions using the predicted industry for the first organization;
aggregate the data regarding transactions for transactions involving organizations in the predicted industry;
creating one or more data views of the aggregated data, each data view indicating a key performance indicator (KPI) for particular metric over a particular time period; and
sending the one or more data views to an insights application for use in displaying the KPI to a user of the insights application.

12. The method of claim 11, wherein the training data is obtained from a plurality of different reference data sets.

13. The method of claim 12, wherein the reference data sets comprise commodity assignments made upon enrollment in the organization-to-organization transaction network.

14. The method of claim 12, wherein the reference data sets comprise Request for (RFX) submissions, which comprise commodity classifications.

15. The method of claim 12, wherein the reference data sets comprise a mapping of commodities to industry.

16. The method of claim 12, wherein the training data comprises labels generated from third party reference data with industry classifications.

17. A non-transitory machine-readable medium storing instructions which, when executed by one or more processors, cause the one or more processors to perform operations comprising:
accessing training data, the training data comprising data regarding one or more organizations and, for each of the one or more organizations, an indication of an industry corresponding to the organization;
training, using a machine learning algorithm, a machine-learned model, the machine-learned model outputting, for an input organization, a predicted industry for the input organization, the training comprising extracting a set of features from the training data and using the indication of industry for each organization to learn a weight for each of one or more of the features, the predicted industry calculated by multiplying a learned weight by a value for each of the one or more features and adding their products to compute a score, the score used by a classifier within the machine-learned model to identify a likeliest industry for the input organization;
obtaining, from a first database in an organization-to-organization transaction network, data regarding transactions;
using information about a first organization as input to the machine-learned model to predict an industry for the first organization;
enriching the data regarding transactions using the predicted industry for the first organization;
aggregate the data regarding transactions for transactions involving organizations in the predicted industry;
creating one or more data views of the aggregated data, each data view indicating a key performance indicator (KPI) for particular metric over a particular time period; and
sending the one or more data views to an insights application for use in displaying the KPI to a user of the insights application.

18. The non-transitory machine-readable medium of claim 17, wherein the insights application comprises a plurality of software widgets, each software widget corresponding to a different data view and defining a graphical presentation for the corresponding data view.

19. The non-transitory machine-readable medium of claim 18, wherein at least one software widget defines a graphical presentation of a first graph type and at least one software widget defines a graphical presentation of a second graph type.

20. The non-transitory machine-readable medium of claim 18, wherein the plurality of software widgets is obtained from a widget database used by a plurality of different insight applications.
